(19) United States
(12) Patent Application Publication
(10) Pub. No.: US 2024/0080678 A1
(43) Pub. Date: Mar. 7, 2024

(54) WIRELESS INDUSTRIAL PROCESS FIELD DEVICE HAVING A PLURALITY OF TRANSCEIVERS

(71) Applicant: Rosemount Inc., Shakopee, MN (US)

(72) Inventors: Laura Anne Schafer, Minneapolis, MN (US); Eric Darrell Rotvold, Mendota Heights, MN (US); Jason Harold Rud, Chanhassen, MN (US); Theodore Henry Schnaare, New Prague, MN (US)

(21) Appl. No.: 18/455,571

(22) Filed: Aug. 24, 2023

Related U.S. Application Data
(60) Provisional application No. 63/400,784, filed on Aug. 25, 2022.

(51) Int. Cl. H04W 16/24; H04L 45/24; H04W 24/08

(52) U.S. Cl. CPC H04W 16/24; H04L 45/24; H04W 24/08; H04W 84/18

(57) ABSTRACT

A wireless industrial process filed device includes a process interface element configured to interface with a process fluid and control or sense a process variable of the process fluid. A controller is configured to control operation of the process interface element. An RF circuit board includes a plurality of RF transceivers carried on the RF circuit board, each configured to send and/or receive an RF signal which carries information related to the process variable. A plurality of antennas are carried on the RF circuit board and form an antenna array. Each of the plurality of antennas is coupled to at least one of the plurality of RF transceivers. Each of the plurality of antennas having a different antenna pattern. The controller controls operation of the plurality of RF transceivers to communicate with a remote device through an antenna array patterned formed by transmission of RF signals through the plurality of antenna patterns of the plurality of antennas.

### CROSS-REFERENCE TO RELATED APPLICATION

The present application is based on and claims the benefit of U.S. provisional patent application Ser. No. 63/400,784, filed Aug. 25, 2022, the content of which is hereby incorporated by reference in its entirety.

### BACKGROUND

The present invention relates to industrial process control or monitoring systems. More specifically, the present invention relates to wireless process field devices used in such systems which has a plurality of transceivers configured to send and/or receive information with a remote device.

In industrial settings, systems are used to monitor and/or control inventories and operation of industrial and chemical processes, and the like. Typically, the system that performs these functions uses field devices distributed at key locations in the industrial process which couple to control circuitry in a control room through a process control loop. The term “field device” refers to any device that performs a function in a distributed process control or process monitoring system, including all devices used in the measurement, control and monitoring of industrial processes.

Typically, each field device also includes communication circuitry that is used for communicating with a process controller, other field devices, or other circuitry, over the process control loop. In some installations, the process control loop is also used to deliver a regulated current and/or voltage to the field device for powering the field device. The process control loop also carries data, either in an analog or digital format.

In some installations, wireless technologies have begun to be used to provide the process control loop and communicate with field devices. Wireless operation simplifies field device wiring and setup. There is an ongoing need for improved wireless communication in industrial field devices.

### SUMMARY

A wireless industrial process field device includes a process interface element configured to interface with a process fluid and control or sense a process variable of the process fluid. A controller is configured to control operation of the process interface element. An RF circuit board includes a plurality of RF transceivers carried on the RF circuit board, each configured to send and/or receive an RF signal which carries information related to the process variable. A plurality of antennas are carried on the RF circuit board and form an antenna array. Each of the plurality of antennas is coupled to at least one of the plurality of RF transceivers. Each of the plurality of antennas having a different antenna pattern. The controller controls operation of the plurality of RF transceivers to communicate with a remote device by transmission of RF signals through the plurality of antennas.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified block diagram of an industrial process monitoring and/or control system including a plurality of wireless field devices.

FIG. 2 is a simplified block diagram of a field device from FIG. 1 including a radio system having a plurality of transceivers.

FIG. 3 is a simplified block diagram of a field device showing a more detailed block diagram of an example configuration of a radio system having a plurality of transceivers.

FIG. 4 is a side view of a field device showing an external radome configuration.

FIG. 5 is a cross-sectional view of a field device 200 showing a radome configured as an end cap.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

As discussed in the Background section, industrial process field devices are used to control and monitor process variables, for example of process fluids, in industrial processes. Example process variables that can be measured or controlled include flow, level, temperature, etc. In some instances, the field devices are configured to operate wirelessly. Wireless communication in industrial processes can be difficult due to power constraints, interfering electrical and RF (radio frequency) signals, obstacles blocking communication paths, among other reasons. One technique used to address these issues is the use of multiple radio transceivers implemented in field devices for communicating with remote devices over more than one RF communication link. One such technique is generally referred to as multi-core radio technology which is described in U.S. Pat. No. 10,165,531, issued Dec. 25, 2018, entitled TRANSMISSION AND RECEPTION OF SIGNALS IN TIME SYNCHRONIZED WIRELESS SENSOR ACTUATOR NETWORK and U.S. application Ser. No. 17/699,169 (US Publication No. 2022/0311584), filed on Mar. 21, 2022 and entitled RF ADAPTIVE DIVERSITY AND METHOD FOR MAXIMIZING CAPACITY IN A WIRELESS TRANSMISSION which are incorporated herein in their entirety.

In various aspects, the present invention provides a wireless industrial process field device which includes a process interface configured to interface with the process fluid and control or sense (measure) a process variable of the process fluid. A controller such as a microprocessor is configured to communicate with the process interface element and thereby sense the process variable using the process interface or control the process variable using the process interface. The wireless field device includes an RF circuit board which includes a plurality of RF transceivers as well as a plurality of antennas. The RF circuit board is arranged in such a way that the antennas can wirelessly communicate to remote devices. For example, the RF circuit board can be placed in an RF transparent radome or other such structure, for example outside of a housing of the wireless industrial process field device. Each of the plurality of antennas is each coupled to at least one RF transceiver. Each of the plurality of antennas has a different antenna pattern due to the configuration and/or orientation of the individual antenna. The controller is configured to communicate with remote devices through one or more of the transceiver/antenna pairs which can be selected based upon the quality, reliability, or some other characteristic of the communication link. Further, the various transceivers/antenna pairs can be used to communicate using multiple different communication protocols to allow communication with different types of wireless devices.

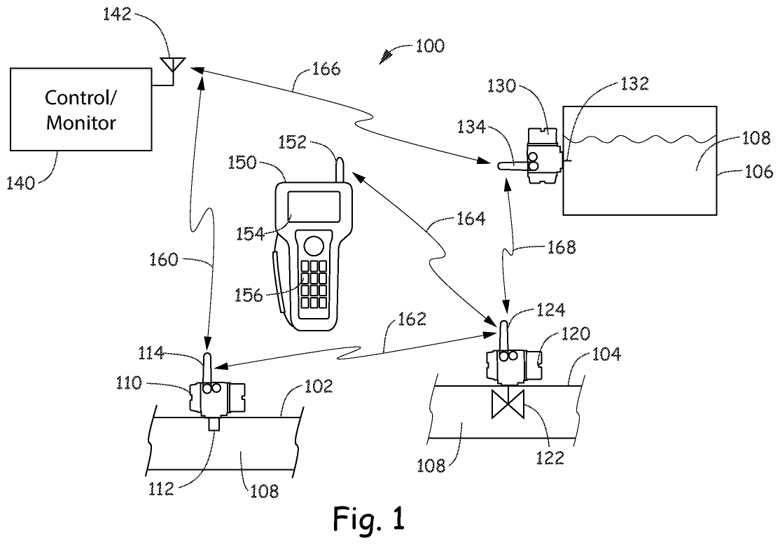

FIG. 1 is a simplified block diagram of an industrial process control or monitoring system 100 used to illustrate aspects of the present invention. System 100 includes various vessels carrying process fluid. For example, pipe 102, pipe 104 and tank or container 106 all carry process fluid 108. Various types of industrial process field devices are also illustrated, including process variable transmitters and a process variable controller. A process field device 110 is configured as a process variable transmitter and includes the process interface element 112 configured as a process variable sensor such as a flow rate sensor configured to sense a flow of process fluid 108 through pipe 102. Process variable transmitter 110 includes an antenna 114 for communicating with remote devices. For example, information related to the sensed process variable (flow rate) can be transmitted to remote devices, as well as diagnostic information. Further, the sensed process variable can be transmitted to a device capable of controlling a process variable and used to directly control the process variable. Configuration information or other commands may be received over this RF communication link. Similarly, a process field device 120 is configured as a process controller and is illustrated as including a process interface element 122 configured as a valve to control flow of process fluid 108 through pipe 104. Process variable controller 120 includes an antenna 124 for communication with remote devices. For example, the field device 120 can receive control commands over the RF communication link instructing it to control a position of the valve 122 and thereby control the flow rate of process fluid 108 through process piping 104. The field device 120 can also transmit diagnostic information or other information over the communication link, as well as receive configuration information.

Another process field device 130 is configured as a variable transmitter and couples to a process interface element configured as a level switch 132. The level switch 132 is another example of process variable sensor and is configured to actuate based upon the level of process fluid 108 in tank 106. Process variable transmitter 130 includes an antenna 134 for communicating with remote devices. The RF communication link can be used to transmit information related to the sensed level of the process fluid 108 as well as diagnostic information or other information. Further, this RF communication link can be used to receive configuration commands, software updates, or other instructions or commands.

A central location such as a control room is configured as a controller/monitor station 140 of the industrial process 100. Control/monitor station 140 includes antenna 142 for use in communicating with process field devices 110, 120 and 130. The station 140 can receive the sensed process variables from process variable transmitters and responsively transmit control commands to process control devices to control operation of the industrial process. This allows the sensed process variables to provide feedback for a control system. The station 140 can also receive or otherwise provide alarms based upon received process variables or diagnostic information, and can send out commands or other instructions to the various different types of process field devices. Alternatively, a gateway (not shown) may be used to communicate with the field devices, with the gateway then communicating (wired or wireless) with the control/monitor station.

FIG. 1 also illustrates an optional configuration device 150 which includes an antenna 152 for communicating with industrial process field devices 110, 120 and/or 130. A user interface is provided which includes a display 154 and a user input 156. The configuration device 150 can be used to provide configuration data to the various field devices 110, 120 and 130. For example, the output from a process variable sensor can be calibrated correlated to a process variable. As a specific example, the output from process variable sensor 112 can be correlated to a specific flow rate of process fluid 108 and such calibration information can be provided by device 150 for storage in a memory of process field device 110. In a controller type field device, configuration information can be provided which correlates a control output to a particular output or position of a process control element. As a specific example, a particular control value can be correlated to a position of valve 122 and/or the resultant flow rate of process fluid 108. The configuration device 150 can also be used to read back diagnostic information from a process variable transmitter or provide control commands to a process variable controller. During commissioning of system 100, the configuration device 150 can be used to provide configuration data such as field device type, location, addressing information, or other configuration information to various field devices.

FIG. 1 illustrates various communication links 160, 162, 164, 166 and 168 which illustrate RF communication links between the various devices. These RF communication links may operate in accordance with any appropriate technology and carry any data as desired. For example, a control command can be sent from station 140 over link 160 to field device 110. This control command can then be relayed from field device 110 to field device 120 over communication link 162. In another example, field device 120 receives a control command from field device 130 over communication link 168. Configuration device 150 is also illustrated as communicating with field device 120 over a communication link 164.

The various RF communication links 160-168 illustrated in FIG. 1 can operate in accordance with any appropriate technology, including different communication standards between different devices. For example, the field devices 110, 120, 130 and the station 140 may communication with one another using WirelessHART® technology in accordance with IEEE standards, (IEC 62591) or ISA 100.11a (IEC 62734), or another wireless communication protocol, such as WiFi, LoRa, Sigfox, BLE, or any other suitable protocol including a custom communication protocol. If devices are in close proximity, for example if configuration device 150 is in close proximity to process field device 120, a different communication standard can be implemented. For example, in one configuration, communication link 164 is in accordance with the Bluetooth® technology communication standard. Further, the various field devices can operate as a mesh network. In one example, a field device is arranged as an access point, relay, or gateway for RF communication and does not need to include a process interface element.

As discussed in the Background section, the use of multiple transceivers provides a platform to enhance reliability and functionality for industrial process communications. For example, by using multiple radio transceivers, the system can be configured to be less susceptible to interference from other RF communication links and is better able to coexist in a crowded RF spectrum. The use of additional radios can also allow for an extended communication range by selecting or coordinating between the various transceivers, as well as increased network capacity and higher data rates. Because multiple communication links and configurations are available to a device, it is possible to select the one which requires the least amount of power for a particular level of reliability and signal quality. This allows lower power utilization, which can be significant in wireless devices which do not have a connection to an external power source. The multiple different RF communication links and configurations can also be used to determine or validate the health of a particular communication link. For example, redundant data can be communicated on multiple links to determine which link provides the most desirable link characteristics. Using multiple transceivers, as discussed above, it is also possible for different devices to communicate using different RF communication techniques and frequencies.

These enhancements are enabled by radio redundancy and optimization schemes to sense the environment and adapt to the device's surroundings. Specific implementations of process field devices with multiple transceiver technology in wireless industrial applications are discussed herein.

Existing industrial wireless systems, may be adequate for some current applications, but with the increasing deployment of wireless products. However, improved levels of reliability and performance as may be required by industrial applications is desirable.

Coexistence in the RF spectrum becomes difficult with the congestion caused by the deployment of a large number of wireless sensors and actuators in a shared RF space. Competing wireless traffic can also come from higher power signaling products such as Wi-Fi. This can cause lower power wireless devices to be susceptible to dropping off the network or missing messages. Wireless congestion will only become a larger problem over time with more wireless applications.

Transmit power for wireless communication is a significant part of the power consumption of a process field device (or “field node”) Typical wireless systems use fixed transmit power to ensure communication reliability regardless of the RF environment. When the environment is not congested and does not require high power for successful transmission, the excess transmission power is wasted, leading to an unnecessarily short battery life. Further, higher transmit power also has the potential to interfere with other nearby users of the shared RF spectrum, which may include other members of the same communication network.

Longer range communication is also desirable as this allows for more remote applications with fewer repeaters/devices needed between the field devices. At longer distances, wireless packets will be lost and eventually the field node will drop off the network. A configuration with multiple transceivers can be used to select more efficient communication links and thereby extend the communication range.

Network capacity is limited with increasing update rates. As the update rate increases (e.g., 1 update per second), the maximum number of field nodes in the network must be decreased. This makes fast update rates on large networks expensive and less desirable. Further, large data packets take significant time to transmit through a mesh network. Again, using multiple transceivers, a more efficient link configuration can be selected to help offset this capacity limitation.

Dynamic sensing of the RF environment typically cannot be performed in single-radio systems without disrupting the primary communication channel. RF characteristics can change with the environment, making the system less efficient and can significantly impact other nodes in the network. However, with multiple RF communication links, one or more of the links can be used for performing diagnostics and determining RF communication characteristics while one or more other links may be used for communicating system data.

Configuration and calibration through a mesh network can take a significant amount of time depending on the number of field nodes messages that need to pass through. Further, directly interacting with a device through a maintenance port requires direct physical connection which is inconvenient, especially when the field node is located in a hazardous area. Using multiple communication links, one or more of the links can be used for maintenance and configuration without interrupting communication on other data communication links

Propagation delay between field nodes may be a significant factor in limiting the amount of data that can be communicated and the speed at which the system can react. For example, a wireless controller may take too long to react to a data event through a mesh network. An example is triggering a remote (wireless) actuator based on a measurement from another field device. Using multiple communication links, this propagation delay between field nodes can be reduced and, in some instances, a direct communication link between nodes can be provided.

The use of multiple transceivers can be used to provide redundant communication paths. This will enable wireless devices to evolve with the changing environment of wireless connectivity by improving reliability, performance, and functionality.

Multiple transceivers incorporate two or more embedded independent but coordinated radios to enhance existing communication protocols. These radios are referred herein as “transceivers”. Although a transceiver typically refers to a device which is bidirectional and capable of both receiving and transmitting data, as used herein “transceiver” also refers to RF communication circuitry which can only receive or only transmit data. These radios can be used to assess the RF environment while standard communication is in process. The information gained through this environmental assessment can be used to adjust communication parameters without interfering with the underlying communication protocol. The behavior of the radios can be adjusted depending on the environment to preserve range and reliability in a crowded RF spectrum, or to save power and increase capacity in clean RF environments.

Network capacity and data throughput can also be improved with the multiple transceivers by simultaneously receiving or transmitting messages to and from multiple field nodes or other wireless devices. For example, one or more communication links can be used for transmitting data while simultaneously one or more other communication links can be utilized for receiving data.

The inherent redundancy of multiple transceivers can be used to enhance mission-critical safety instrumented system (SIS) applications where data reliability is critical. Among other things, the use of multiple transceivers enables the implementation of a voting scheme to determine the “best” communication parameters (e.g., timing, channel, antenna, etc.) to use to ensure data reliability.

Multiple transceivers can also be used to independently assess the health of various parts of the wireless communication system (RF connections, antennas, channels, paths, temporal impairments, etc.). A signal is transmitted by one radio and received by one or more other radio of the same multi transceiver device in order to conduct a health assessment of the signal path. A relative comparison can then be conducted between transceivers and between current performance and a performance signature captured during manufacturing, commissioning, or at some other point or points in the past. These comparisons are used to assess signal path characteristic changes and their impact on communication performance, including component degradation and drift or environmental effects. The collected signal path quality information can be used dynamically to maintain the “best” possible performance (e.g., do not use transceivers that have degraded performance) and can be communicated to the user, so the node can be repaired or replaced.

Bluetooth® technology is used today as a method to configure and collect data directly from wired HART® technology and other industrial products without a physical direct connection. Interaction between a WirelessHART® technology field node and a configurator or calibrator can be improved by using one transceiver as a local configuration interface using a local communication standard (e.g., Bluetooth® technology). This will allow configuration activities without affecting the primary communication channel (e.g., WirelessHART® technology) since both protocols could be active simultaneously. This allows for convenient configuration of the field node before it is connected and authenticated into the primary communication network. The same concept can be used to enable over-the-air firmware updates without interrupting the primary communication channel.

Similarly, multiple point to point wireless field channels can be utilized to ‘share’ information with neighboring field nodes or other devices (e.g., a wireless handheld device) to improve speed of control or reactions while still maintaining a connection to the primary communication network. The shared data can be used for triggering actuators quickly based on a measurement made in another field node. Another example is using the shared data in an augmented reality overlay for products to quickly provide the user with measurements or status when looking at the field node. For example, a real time or stored image or schematic representation of system 100 can be displayed on display 154 of configuration device 150 along with the status or measurement data. Other display techniques or technologies may also be implemented.

Implementation of multi transceiver technology into practical and economical field nodes is complicated by the need to attach multiple antennas. Typically, antenna connections in such devices are made using expensive coaxial cables or tuned copper strip lines on printed circuit boards. One means of efficiently connecting antennas to a plurality of transceivers is to deploy the radio transceivers on the same circuit board (PCB) substrate as the antennas. For example, mounting both the transceivers and the antennas in the form of integrated circuit chips, stamped metal, copper circuit board features or other types of components on a circuit board located within an RF transparent radome. This also enables a low-cost implementation in existing wireless field nodes that are constructed of conductive materials and have external RF transparent radomes.

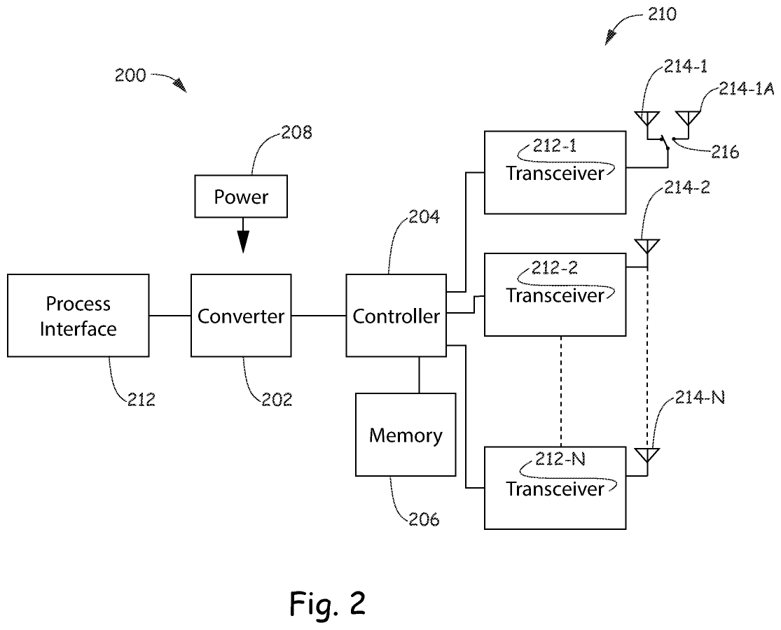

FIG. 2 is a simplified block diagram of a wireless field device 200 including a process interface 212 configured to sense a process variable or control a process variable of an industrial process. Field device 200 includes a converter 202 which, for example, can be configured as an analog to digital or digital to analog converter which couples the field interface 212 to a controller 204 which can comprise, for example, a microprocessor. Controller 204 operates in accordance with instructions and configuration information stored in a memory 206. Further, memory 206 can be used to temporarily store information while the field device is operating. A power supply 208 is shown and is used to provide power to the various components within the field device 200. The power supply 208 can be, for example, a battery that the field device is completely wireless. Optional battery charging components can be provided, such as solar cells or the like. If operating in a partially wirelessly configuration, field device 200 may also couple to an external power supply to provide power to power supply 208. FIG. 2 also illustrates a multi transceiver arrangement 210 which is illustrated as a plurality of transceivers identified as transceiver 212-1, 212-2 . . . 212-N. These transceivers can be arranged to both transmit and receive RF communication, or, can be configured to only receive or only transmit such RF communications. Each of the transceivers is coupled to an antenna illustrated at 214-1, 214-2 . . . 214-N. Typically, each transceiver will couple to at least one antenna. However, in FIG. 2 transceiver 212-1 is shown as being optionally coupled to a second antenna 214-1A by operation of a switch 216. The switch 216 can be operated, for example, by controller 204, transceiver 212-1, or circuitry within the system 210.

During operation, controller 204 of field device 200 is able to communicate with remote devices using transceiver system 210 communicating through antennas 214. The various features and configurations discussed above can be implemented by communicating using different transceivers and antennas. The controller 204 can transmit a process variable sensed by process interface 212 and received through an analog to digital converter 202 using a transceiver 212-1. The same process variable can be redundantly transmitted using a second transceiver. In another example, a second transceiver such as transceiver 212-2 is used to communicate with another field device, for example configuration unit 150. In such a configuration, process variable or control information can be communicated using, for example, WirelessHart® technology to a remote field device or station 140. At the same time, transceiver 212-2 can communicate with configuration device 150 using a more local communication technique, such as Bluetooth® technology. While communicating over other transceivers, field device 200 can utilize transceiver 212-N to communicate with another remote device, or the same remote device, in order to evaluate characteristics of the communication link such as signal strength, data loss, etc. This allows the controller 204 (or radio system 210) to select the “best” communication link based upon a predetermined set of communication requirements.

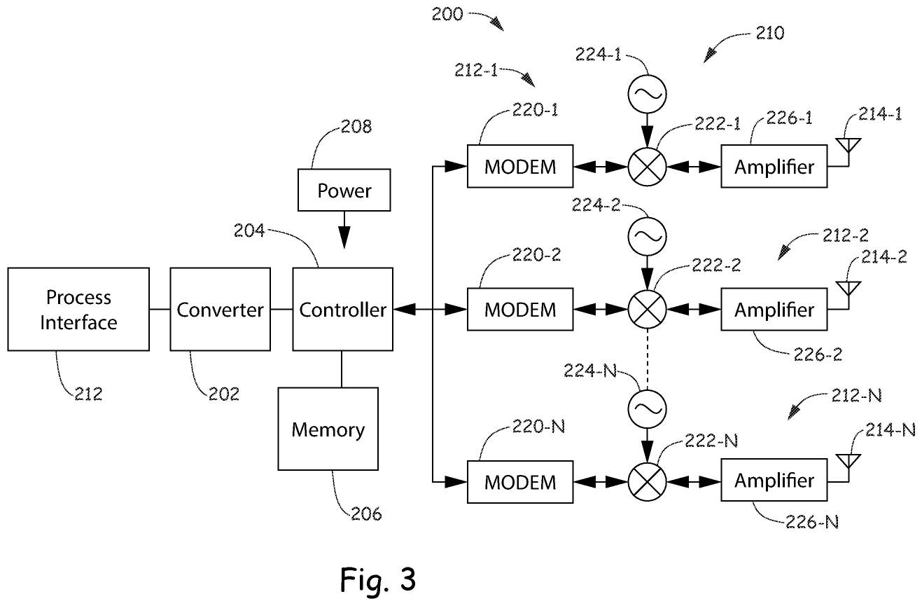

FIG. 3 is another simplified block diagram of field device 200 and shows one example configuration of radio system 210 in more detail. As illustrated in FIG. 3, each transceiver, for example 212-1, includes a modulator/demodulator (MODEM) 220-1. Although a MODEM is illustrated, any type of encoding and decoding technique can be implemented in a particular transceiver. The MODEM is used to encode or decode data received or transmitted on the RF communication link with the controller 204. A mixer 222-1 is illustrated which receives a mixing signal from a local oscillator 224-1. Depending upon the configuration of transceiver 212-1, the mixer 222-1 is used to up convert the output from MODEM 220-1 to an RF signal, or down convert a received RF signal from amplifier 226-1. Again, depending on the configuration of transceiver 212-1, amplifier 226-1 is used to amplify an RF signal received from antenna 214-1 or amplify an output from mixer 222-1. Note that the components in transceiver 212-2 and 212-N contain a similar numbering scheme.

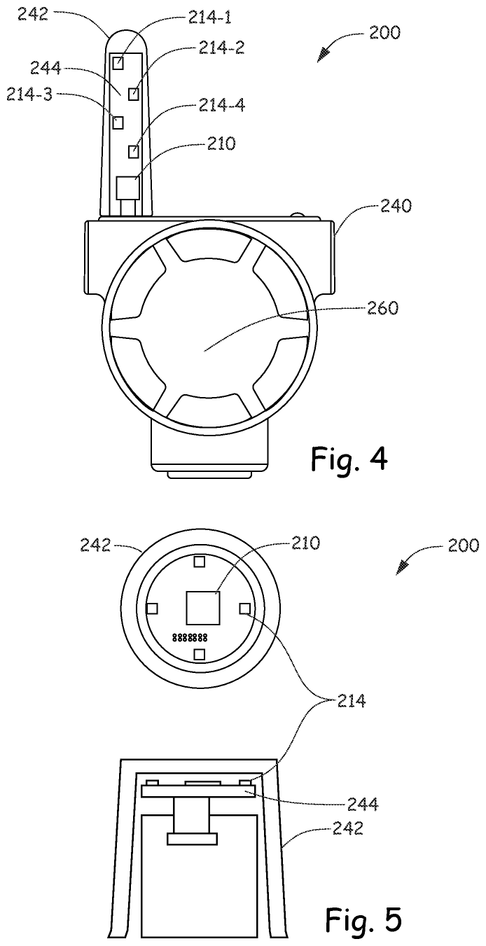

FIG. 4 shows an example physical implementation of field device 200. As illustrated in FIG. 4, field device 200 includes a housing 240 which is typically formed of metal or other RF opaque material. The housing 240 typically contains, for example, converter 202, controller 204 and memory 206. In some configurations, the power supply 208 is also contained within housing 250. As the housing 240 is typically opaque to RF communication, a radome 242 is provided to field device 200 which does not block RF signals. The radome 242 in the configuration of FIG. 4 comprises an elongate housing. An RF printed circuit board (PCB) substrate 244 can be carried within the radome 242. A multi transceiver system 210 is implemented on RF circuit board 244. Individual antennas 214-1 . . . 214-4 are also carried on PCB 244 and coupled to the transceiver system 210. This configuration allows for a simplified RF wiring connection between the transceiver system 210 and the individual antennas 214. Electrical power and data connections can be provided at the base of RF Circuit board 244 which connect the circuitry carried on RF circuit board 244 to controller 204.

FIG. 5 shows another example configuration of a radome 242. In this configuration, radome 242 is implemented as an end cap, for example, end cap 260 shown in FIG. 4, of the field device 200. In this implementation, the RF circuit board 244 has a disc configuration similar to the end cap 260.

Although the present invention has been described with reference to preferred embodiments, workers skilled in the art will recognize that changes may be made in form and detail without departing from the spirit and scope of the invention. The controller can be implemented by, for example, a microprocessor or other device. The antennas 214 provide an antenna pattern based on their configuration and orientation. Multiple transceiver/antenna pairs can be used to generate an antenna array pattern which is formed based upon the individual antenna patterns generated by each antenna. For example, this allows the antenna array pattern to be altered or “steered” electronically during operation of the device.

What is claimed is:

1. A wireless industrial process field device, comprising:
a process interface element configured to interface with a process fluid and control or sense a process variable of the process fluid;
a controller configured to communicate with the process interface element;
an RF circuit board;
a plurality of RF transceivers carried on the RF circuit board and each configured to send or receive an RF signal, at least one RF signal containing information related to the process variable;
a plurality of antennas carried on the RF circuit board each coupled to one of the plurality of RF transceivers, each of the plurality of antennas having a different antenna pattern; and
wherein the controller controls operation of the plurality of RF transceivers to communicate with a remote device through transmission of RF signals through at least one of the plurality of antennas.

2. The wireless industrial process field device of claim 1 wherein the plurality of RF transceivers is used to increase the data transmission capacity.

3. The wireless industrial process field device of claim 1 wherein the plurality of RF transceivers is used to improve communication range, reliability, and power consumption by creating parallel streams of data with different path lengths and/or though different nodes of a mesh network.

4. The wireless industrial process field device of claim 1 wherein the plurality of RF transceivers communicate using different communication protocols.

5. The wireless industrial process field device of claim 1 wherein one transceiver is used to communicate information related to the process variable and another transceiver is used to communicate configuration information.

6. The wireless industrial process field device of claim 1 wherein one transceiver is used to communicate information related to the process variable and another transceiver is used to communicate diagnostic information.

7. The wireless industrial process field device of claim 1 wherein one transceiver is used to communicate information related to the process variable and another transceiver is used to communicate device firmware.

8. The wireless industrial process field device of claim 1 wherein the plurality of transceivers are used to independently assess the health of connections between neighboring field nodes.

9. The wireless industrial process field device of claim 1 wherein the plurality of transceivers are used to conduct diagnostics by transmission of a test signal by one transceiver which is received by one or more other transceivers in order to conduct a health assessment of the signal path and perform a relative comparison between transceivers and between current performance and a stored performance signature.

10. The wireless industrial process field device of claim 1 wherein the plurality of transceivers are carried on a shared circuit board substrate with the supporting antennas.

11. The wireless industrial process field device of claim 1 wherein the plurality of transceivers employ a voting scheme to determine the best communication parameters to use to ensure data reliability.

12. The wireless industrial process field device of claim 1 wherein the plurality of antennas are positioned outside of a metal housing.

13. The wireless industrial process field device of claim 1 wherein one of the plurality of transceivers is configured to communicate with a local configuration device.

14. The wireless industrial process field device of claim 1 wherein one of the plurality of transceivers is configured to communicate with another wireless industrial process field device.

15. The wireless industrial process field device of claim 1 wherein one of the plurality of transceivers is configured to dynamically sense RF characteristics of the environment.

16. The wireless industrial process field device of claim 1 wherein the plurality of transceivers are configured to communicate on different frequencies.

17. The wireless industrial process field device of claim 1 wherein the plurality of transceivers are configured to provide redundant communication paths.

18. The wireless industrial process field device of claim 1 wherein one of the plurality of transceivers is configured to communicate with a configuration device which includes a display which displays a schematic representation of a plurality of wireless industrial field devices in an industrial process.

19. The wireless industrial process field device of claim 1 including a metal housing and an RF transparent end cap.

20. The wireless industrial process field device of claim 1 wherein the plurality of antenna patterns are used to form an antenna array pattern.
